(19) United States
(12) Patent Application Publication
(10) Pub. No.: US 2025/0148049 A1
(43) Pub. Date: May 8, 2025

(54) FULL-ANALOG VECTOR MATRIX MULTIPLICATION PROCESSING-IN-MEMORY CIRCUIT AND OPERATION METHOD THEREOF, COMPUTER DEVICE, AND COMPUTER-READABLE STORAGE MEDIUM

(71) Applicant: Peking University, Beijing (CN)

(72) Inventors: Zongwei WANG, Beijing (CN); Yimao CAI, Beijing (CN); Ru HUANG, Beijing (CN)

(21) Appl. No.: 18/862,109

(22) PCT Filed: Nov. 16, 2023
(86) PCT No.: PCT/CN2023/132035

§ 371 Date: Oct. 31, 2024

(30) Foreign Application Priority Data
Nov. 16, 2022 (CN) 202211461099.6

(51) Int. Cl. G06F 17/16

(52) U.S. Cl. CPC G06F 17/16

(57) ABSTRACT

A full-analog vector matrix multiplication process-in-memory circuit comprises: an input circuit, a device array, an output clamping circuit, and an analog shift-and-add unit. The input circuit is used for sampling and holding analog input data and inputting the sampled analog input data into an array. The device array consists of resistive devices and is used for storing a weight value in the form of conductance and performing vector matrix multiplication calculation on the analog input data and the weight value. The output clamping circuit is used for clamping an output point of the device array to a zero level and converting a calculation result in the form of current into a result in the form of voltage for output. The analog shift-and-add unit is used for shifting and adding calculation results of devices in columns of the device array to complete carry calculation.

### CROSS REFERENCE TO RELATED DISCLOSURE

The present application is a US national stage application of PCT international application PCT/CN2023/132035, filed on Nov. 16, 2023, which claims priority to Chinese Patent Disclosure with No. 202211461099.6, entitled “Full-Analog Vector Matrix Multiplication Processing-in-memory Circuit and Operation Method thereof, Computer Device, and Computer-Readable Storage Medium”, and filed on Nov. 16, 2022, the content of which is expressly incorporated herein by reference in its entirety.

### TECHNICAL FIELD

The present disclosure relates to the field of semiconductors and processing-in-memory circuit technologies related to CMOS ultra large scale integration (ULSI), and particularly to a full-analog vector matrix multiplication processing-in-memory circuit and an operation method thereof, a computer device, and a computer-readable storage medium.

### BACKGROUND

With the development of artificial intelligence and deep learning technologies, artificial neural networks are widely used in fields such as natural language processing, image recognition, autonomous driving, and graph neural networks, etc. However, an increasing network size causes a large amount of energy to be consumed for data transfer between a memory and a conventional computing device such as a CPU or a GPU, which is referred to as the von Neumann bottleneck. The computation that occupies the most important part in the artificial neural network algorithm is the vector matrix multiplication (VMM) computation. The processing-in-memory means that weight values are stored in memory array units, and vector matrix multiplication computation is performed on the array, so as to avoid frequent data transfer between the memory and the computing units. Accordingly, the processing-in-memory is considered as a promising way to break through the von Neumann bottleneck.

As shown in FIG. 1, it is a schematic circuit diagram in which a digital-analog hybrid compute mode is generally used for processing-in-memory in the conventional technology. A memory unit may be a transitory memory such as a Static Random Access Memory (SRAM) or a Dynamic Random Access Memory (DRAM), or may be a non-transitory memory such as a flash memory, a Resistive Random Access Memory (RRAM), a Phase Chalcogenide Random Access Memory (PCRAM), or a Magnetic Random Access Memory (MRAM), etc. FIG. 2 is a schematic diagram of a vector matrix multiplication circuit for processing-in-memory digital-analog hybrid computation in the conventional technology. The weight value is represented by a device conductance value in the memory array, and an input feature map is a digital quantity stored in the digital memory. When the vector matrix multiplication computation is implemented, a feature map stored in the digital memory is converted into an analog voltage input array by using a digital-to-analog converter (DAC), a vector multiplication computation in an analog domain is performed in the array, and a computation result is represented as a sum of currents on a bit line, and then converted into a digital quantity by using an analog-to-digital converter (ADC), and finally transmitted back to the digital memory for storage.

However, areas and power consumptions of high-precision DACs and ADCs increase exponentially with precision. The neural network is usually composed of dozens or even hundreds of layers, and the analog-to-digital (A/D) and digital-to-analog (D/A) conversions of the data between the layers consumes a large amount of energy. In a case where a pure analog computation is used in an existing work, the A/D conversion is not performed between the neural network layers, and an analog voltage outputted from the upper layer directly serves as an input of the lower layer (as shown in FIG. 3). In this manner, the inputs and outputs are analog quantities, and the analog device is also required to express a high-precision weight value.

A multi-value process of the existing resistive devices such as the RRAM, PCRAM, and MRAM is not mature. Therefore, in a neural network processing-in-memory system with a high precision requirement, a plurality of low-precision devices (for example, a binary device) are commonly employed to represent each binary bit of a high-precision weight value. However, in the existing solution of a pure analog computation vector matrix multiplication, an analog device is also required, but a low-precision device (such as a binary device) with a more mature process cannot be directly used, and a problem of how to implement carry and maintain computation precision in an analog circuit by using a low-precision device is not solved.

### SUMMARY

The present disclosure provides a full-analog-domain processing-in-memory circuit for implementing full-analog vector matrix multiplication computation with a high precision by using a low-precision device (for example, a binary device). Different from the conventional processing-in-memory in the digital-to-analog hybrid compute mode, the circuit in the present disclosure completely works in an analog domain, which avoids frequent digital-to-analog and analog-to-digital conversions in the complex neural network processing-in-memory. The input does not need to be converted to an analog quantity through the DAC, the output of the device array does not need to be converted to a digital quantity through the ADC, and an area and power consumption of the processing-in-memory circuit are effectively improved. In addition, a high-precision vector matrix multiplication computation is implemented by using an array formed by low-precision devices having a more mature process, each binary bit of a high-precision weight value are stored in a plurality of low-precision devices, and the carrying computation is directly implemented in the analog domain after the vector matrix multiplication is completed in the device array. Compared to the conventional pure analog processing-in-memory design in which an analog device is used, the low-precision device has a higher reliability, and the computation precision is improved.

In view of this, the technical solution of the present disclosure is provided as follows.

In the first aspect of the present disclosure, a full-analog vector matrix multiplication processing-in-memory circuit is provided, including an input circuit, a device array, an output clamp circuit, and an analog shift summation unit; the input circuit is configured to sample and hold analog input data, and input the sampled analog input data into the device array; the device array consists of resistive devices, and is configured to store a weight value in a form of conductance and perform vector matrix multiplication computation on the analog input data and the weight value; the output clamp circuit is configured to clamp an output point of the device array to a zero level, and convert a computation result in a form of current to an output result in a form of voltage; and the analog shift summation unit is configured to perform a shift summation on computation results of columns of devices in the device array to complete a carrying computation.

Further, the input circuit is sample and hold circuit.

Further, the analog shift summation unit includes column capacitors each of which has a one-to-one correspondence with each column in the device array, a redundant capacitor and a voltage follower, a column capacitor is configured to temporarily store a computation result of each column of devices, the redundant capacitor is configured to perform a weighted summation on the computation results of the columns in the device array, the voltage follower is configured to output a final shift summation result.

Further, the column capacitors corresponding to the columns in the device array have the same capacitance size, and the redundant capacitor has the same capacitance size with a column capacitor.

Further, the analog shift summation unit is further configured to connect the redundant capacitor to each column capacitor and disconnect the redundant capacitor from each column capacitor successively to perform charge distribution, perform the weighted summation on the computation results of the columns of devices, and perform the shift summation according to a result of the weighted summation.

Further, the final result of the shift summation outputted by the voltage follower is represented as V_{O}=Σᵢ₌₀ⁿ⁻¹2ⁱ⁻ⁿVᵢ, where n denotes the number of the column capacitors.

In the second aspect of the present disclosure, an operation method for the full-analog vector matrix multiplication processing-in-memory circuit is provided, the method includes:
inputting analog input data into the device array through the input circuit;
performing vector matrix multiplication computation on the analog input data and a weight value stored in the device array according to Kirhoff's law and Ohm's law;
clamping, by the output clamp circuit, an output point of the device array to a zero level, and converting a computation result in a form of current into an output result in a form of voltage; and
performing, by the analog shift summation unit, a shift summation on computation results of columns of devices in the device array to complete a carrying computation.

Further, the performing, by the analog shift summation unit, the shift summation on the computation results of columns of devices in the device array to complete the carrying computation includes:
connecting the redundant capacitor to each column capacitor and disconnecting the redundant capacitor from each column capacitor successively to perform the charge distribution, performing a weighted summation on the computation results of the columns of devices, performing a shift summation according to a result of the weighted summation, and outputting, by the voltage follower, a final result of the shift summation.

Further, the final result of the shift summation outputted by the voltage follower is V_{O}=Σᵢ₌₀ⁿ⁻¹2ⁱ⁻ⁿVᵢ, where n denotes the number of the column capacitors.

Further, for the computation of an N-bit weight value, the step of inputting the analog input data into the device array alternates with the step of the computation of the array vector matrix multiplication, and the shift summation is completed with (N/2+1) analog shift summation units, to implement a pipeline operation of the circuit.

In the third aspect of the present disclosure, a computer device is provided, including a processor and a memory storing a computer program executable on the processor, when executing the computer program, the processor implements the method in the above-mentioned second aspect.

In the fourth aspect of the present disclosure, a computer-readable storage medium is provided, on which a computer program is stored, the computer program, when being executed by a processor, causes the processor to implement the method in the above-mentioned second aspect.

The full-analog vector matrix multiplication processing-in-memory circuit provided in the present disclosure has the following advantages.

The full-analog vector matrix multiplication processing-in-memory circuit operates in the analog domain, omitting the ADC and DAC included in the commonly used processing-in-memory design, i.e., there is no frequent A/D conversions, and has significant advantages in terms of energy efficiency and area. In place of the analog device, more mature low-precision devices are used, and a plurality of low-precision devices are utilized to represent a binary bit of a weight value in the neural network, thereby improving the computation precision. The proposed analog shift summation unit solves the carrying computation of the low-precision devices in the analog domain during the processing-in-memory, and the computation precision is maintained. According to the proposed full-analog processing-in-memory circuit, a pipeline operation mode is implemented by using a plurality of analog shift summation units, thereby effectively improving the computational efficiency.

### BRIEF DESCRIPTION OF THE DRAWINGS

FIG. 1 is a schematic circuit diagram of a vector matrix multiplication based on a digital-to-analog hybrid processing-in-memory in a conventional technology.

FIG. 2 is a schematic circuit diagram of a vector matrix multiplication based on a digital-to-analog hybrid processing-in-memory in a conventional technology.

FIG. 3 is a schematic circuit diagram of a vector matrix multiplication for implementing a pure analog computation by using an analog device in a conventional technology.

FIG. 4 is a schematic circuit diagram of performing full-analog vector matrix multiplication by using a low-precision device according to an embodiment of the present disclosure.

FIG. 5 is a schematic diagram of a computation workflow of an analog shift summation unit according to an embodiment of the present disclosure.

FIG. 6 is a schematic diagram of an operation pipeline of a full-analog vector matrix multiplication circuit according to an embodiment of the present disclosure.

FIG. 7 is a flow chart showing an operation method of a full-analog vector matrix multiplication processing-in-memory circuit according to an embodiment of the present disclosure.

FIG. 8 is an internal structure diagram of a computer device according to an embodiment of the present disclosure.

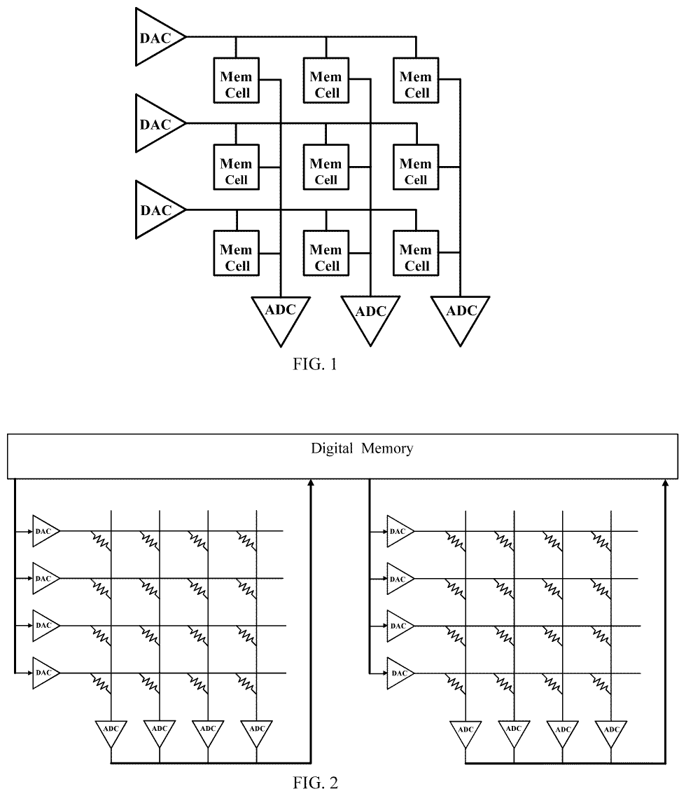

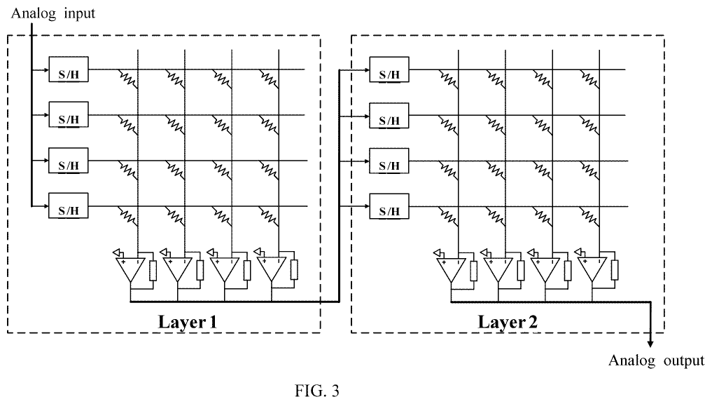

### DETAILED DESCRIPTION

To facilitate understanding of the present disclosure, the present disclosure will be described more comprehensively below with reference to the relevant accompanying drawings. Embodiments of the present disclosure are shown in the accompanying drawings. However, the present disclosure may be implemented in many different forms and is not limited to the embodiments described herein. Rather, the purpose of providing these embodiments is to make the present disclosure more thorough and complete.

Unless defined otherwise, all technical and scientific terms used herein have the same meaning as commonly understood by those skilled in the art to which the present disclosure belongs. The terms used in the specification of the present disclosure are merely for the purpose of describing specific embodiments and are not intended to limit the present disclosure.

The present disclosure will be further clearly and completely described below through specific embodiments in conjunction with the accompanying drawings.

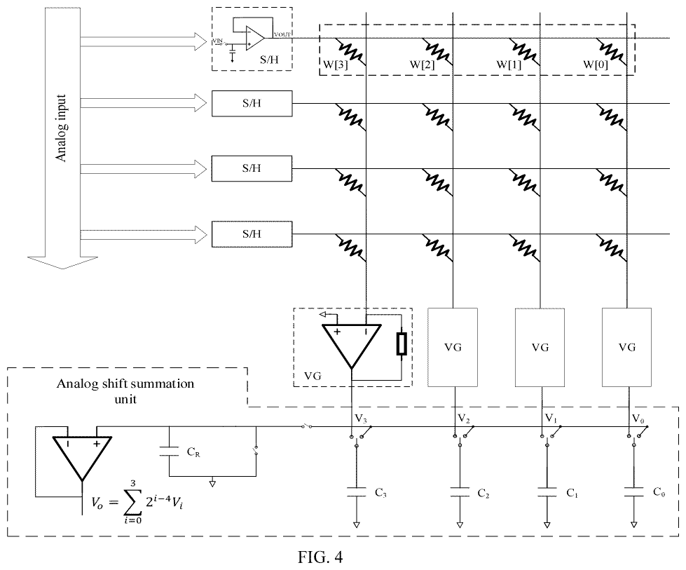

In an embodiment of the present disclosure, as shown in FIG. 4, a full-analog vector matrix multiplication processing-in-memory circuit is provided, and the circuit includes an input circuit, a device array, an output clamp circuit, and an analog shift summation unit. The input circuit may include a sample and hold circuit (S/H) which is configured to sample and hold analog input data, and input the sampled analog input data into the device array. The device array consists of resistive devices, i.e., low-precision devices, and is configured to store weight values in a form of conductance. According to Kirchhoff's law and Ohm's law, the analog input data is multiplied by the conductance to complete the vector matrix multiplication computation of the input data and the weight values. The output clamp circuit (VG) is configured to clamp an output point of the device array to a zero level, and convert a computation result in a form of current to an output result in a form of voltage. Since a low-precision device is employed to represent each binary bit of a weight value to improve the computation precision, computation results of the columns needs to be shifted and added to complete the carrying computation. In order to address the carrying computation in an analog domain, a circuit structure of an analog shift summation unit is designed in the embodiment. The analog shift summation unit may include column capacitors each of which has a one-to-one correspondence with each column in the device array, and may further include a redundant capacitor C_{R} and a voltage follower. The column capacitor is configured to temporarily store a computation result of each column of devices. The redundant capacitor C_{R} is configured to perform a weighted summation on the computation results of the columns. The voltage follower is configured to output a final shift summation result. The analog shift summation unit performs the shift summation on the outputted computation results. The circuit in the embodiment does not need to perform the digital-to-analog (D/A) and analog-to-digital (A/D) conversions for the processing-in-memory, and the shift summation of the results is implemented by using the principle of capacitor charging and charge distribution, thereby implementing the full-analog high-precision vector matrix multiplication.

There may exist one or more sample and hold (S/H) circuits in the embodiment, there may exist one or more resistive devices, there may exist one or more analog shift summation units, and there may exist one or more output clamp circuits (VGs), which are not limited in the present disclosure.

In the present disclosure, the full-analog vector matrix multiplication processing-in-memory circuit can implement the pipeline operation of the circuit. In an embodiment, when a single analog shift summation unit is used, and after the output clamp circuit outputs the array computation results to the analog shift summation unit to perform the shift summation computation, there is no new analog input, no new vector matrix multiplication is performed in the array, and the input circuit and the array are in an idle state. In another embodiment, when (N/2+1) analog shift summation units are used simultaneously, where N is the bit number of the weight value, the analog input may alternate with the vector matrix multiplication of the array, to implement the pipeline operation of the circuit and maximize the computation efficiency of the circuit.

Specifically, FIG. 4 is further taken as an example for description. FIG. 4 is a schematic circuit diagram of full-analog vector matrix multiplication according to a specific embodiment of the present disclosure. In FIG. 4, a 4-bit weight value is represented by four binary devices, where W[i]₍ᵢ₌₀₋₃₎ represents each binary bit of the 4-bit weight value, and the array is a four-input and four-output array. In the first clock cycle, the analog input data is inputted into the sample and hold circuit through a bus. In the second clock cycle, a vector matrix multiplication is performed on the analog input data and a stored weight value in the array according to the Kirchhoff's law and Ohm's law, and the computation results are converted from a current form to a voltage form through the output clamp circuit VG. From the third clock cycle to the sixth clock cycle, the analog shift summation unit completes the shift summation of the computation results. That is, in the analog shift summation unit, Cᵢ₍ᵢ₌₀₋₃₎ denotes column capacitors with the same capacitance, and each of which is configured to temporarily store a computation result of one of the columns. C_{R} denotes a redundant capacitor with the same capacitance size as the column capacitor and is configured to perform the weighted summation on the computation results.

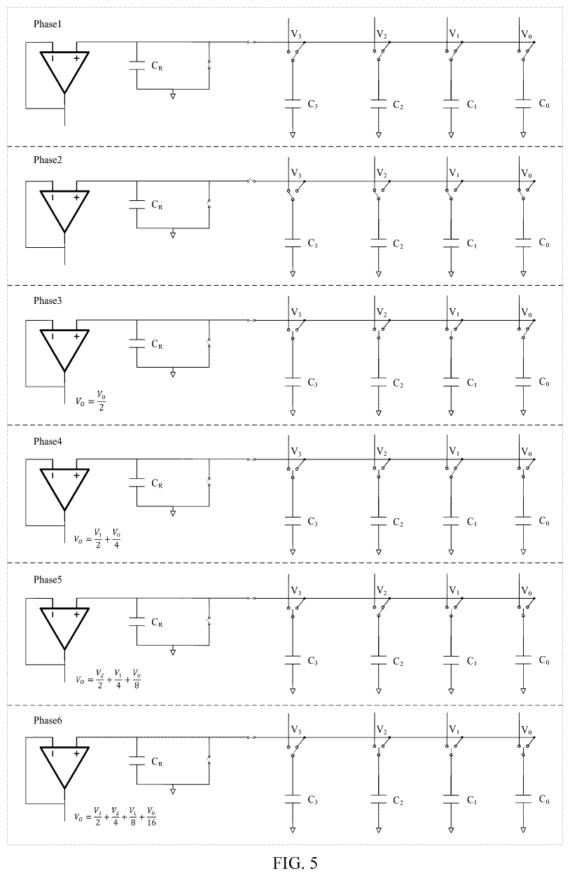

FIG. 5 shows a computation process of an analog shift summation unit according to a specific embodiment of the present disclosure. Specifically, an analog input is first performed in the first clock cycle, meanwhile the analog shift summation unit is initialized, and all capacitors are reset. In the second clock cycle, a vector matrix multiplication in the array is performed, and the computation results in the form of current are converted into computation results in the form of voltage, and the computation results are stored in corresponding column capacitors. In the third clock cycle, C_{R} is connected to C₀ to perform charge redistribution. Since the capacitors have the same capacitance, the voltage follower outputs

$${V}_{O} = \frac{{V}_{0}}{2} .$$

In the fourth clock cycle, C_{R} is disconnected from C₀ and is connected to C₁, the voltage follower outputs

$${V}_{O} = \frac{{V}_{1}}{2} + \frac{{V}_{0}}{4} .$$

In such a manner, C_{R} is connected to and disconnected from C₀, C₁, C₂, C₃ successively to perform the charge distribution, the shift summation of the computation results can be completed by the sixth clock cycle, and the voltage follower finally output V_{O}=Σᵢ₌₀ⁿ⁻¹2ⁱ⁻ⁿVᵢ. When only one analog shift summation unit is used, from the third clock cycle to the sixth clock cycle, there is no new analog input data for the vector matrix multiplication.

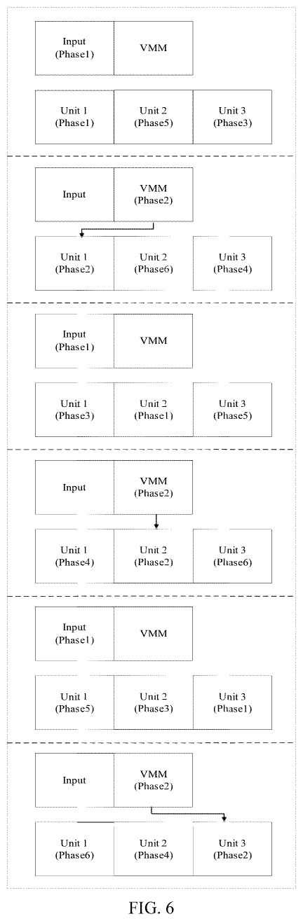

In another embodiment, in order to improve computational efficiency, a plurality of analog shift summation units can be provided and used simultaneously. The circuit can implement the pipeline operation mode, so that the input of the analog input data in the first clock cycle can alternate with the vector matrix multiplication in the second clock cycle. In an embodiment, FIG. 6 is taken as an example for description. FIG. 6 is a schematic diagram of pipeline operation of a full-analog vector matrix multiplication circuit. Similar to the embodiment in FIG. 4, when the weight value is represented as 4-bit, the pipeline operation can be implemented by using three analog shift summation units simultaneously. For ease of description, the three analog shift summation units are respectively referred to as a unit 1, a unit 2, and a unit 3. When the unit 1 enters the third clock cycle, the unit 2 starts the first clock cycle, and the circuit performs the analog input. When the unit 1 enters the fourth clock cycle, the unit 2 starts the second clock cycle, and the vector matrix multiplication is performed in the array. For the unit 3, similarly, when the unit 2 enters the third clock cycle, the unit 3 starts the first clock cycle. When the unit 2 enters the fourth clock cycle, the unit 3 starts the second clock cycle. In such a manner, after completing the operation in the sixth clock cycle, the unit 1 may reperform the operation in the first clock cycle, that is, the analog input. By such a cyclic operation, the circuit implements a pipeline operation manner. Further, for an application of N-bit weight value, the pipeline operation can be implemented by using (N/2+1) analog shift summation units simultaneously, so that the computational efficiency is maximized.

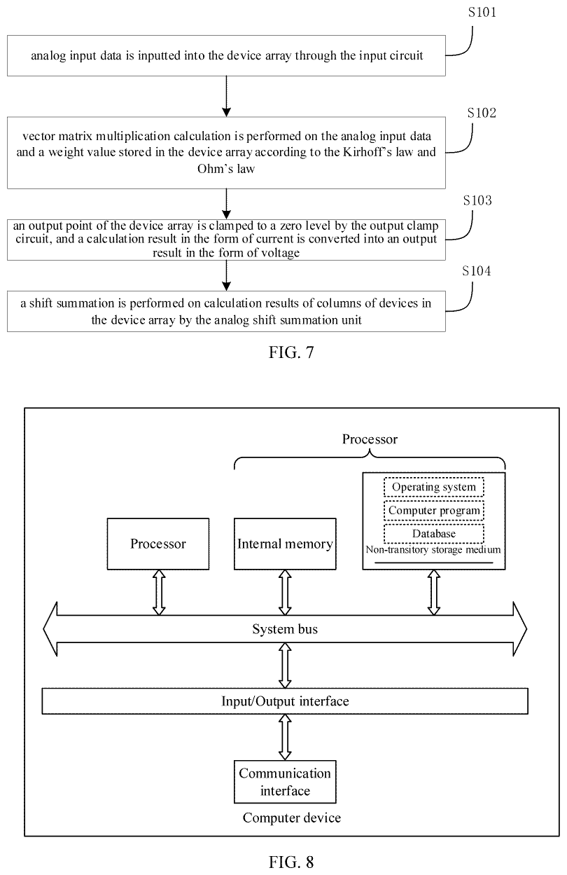

In an embodiment, referring to FIG. 7, it shows a flow chart of an operation method for the above-mentioned full-analog vector matrix multiplication processing-in-memory circuit. In the embodiment, the method is applied to a terminal as an example for illustration. It should be appreciated that the method may also be applied to a system including a terminal and a server, and is implemented by means of interaction between the terminal and the server. As shown in FIG. 7, the operation method may include the following steps.

S101: analog input data is inputted into the device array through the input circuit.

S102: vector matrix multiplication computation is performed on the analog input data and a weight value stored in the device array according to the Kirhoff's law and Ohm's law.

S103: an output point of the device array is clamped to a zero level by the output clamp circuit, and a computation result in the form of current is converted into an output result in the form of voltage.

S104: a shift summation is performed on computation results of columns of devices in the device array by the analog shift summation unit.

In an embodiment, the step that the shift summation is performed on computation results of columns of devices in the device array by the analog shift summation unit may further include:

the redundant capacitor is connected to and disconnected from each column capacitor successively to perform the charge distribution, weighted summation is performed on the computation results of the columns of devices, shift summation is performed according to a result of the weighted summation, and a final result of the shift summation is outputted by the voltage follower.

In an embodiment, the final result of the shift summation outputted by the voltage follower is V_{O}=Σᵢ₌₀ⁿ⁻¹2ⁱ⁻ⁿVᵢ, where n denotes the number of column capacitors.

In an embodiment, for the computation of an N-bit weight value, the step of inputting the analog input data into the device array may alternate with the step of the computation of the array vector matrix multiplication, and the shift summation is completed with (N/2+1) analog shift summation units, to implement the pipeline operation of the circuit.

In an embodiment, a computer device is provided. The computer device may be a server, and an internal structure diagram of the computer device may be as shown in FIG. 8. The computer device may include a processor, a memory, an Input/Output (I/O for short) interface, and a communication interface. The processor, the memory, and the input/output interface are connected to each other through the system bus, and the communication interface is connected to the system bus through the input/output interface. The processor of the computer device is configured to provide computing and control capabilities. The memory of the computer device includes a non-transitory storage medium and an internal memory. The non-transitory storage medium stores an operating system, a computer program, and a database. The internal memory provides an environment for operation of the operating system and the computer program in the non-transitory storage medium. The database of the computer device is configured to store data information. The input/output interface of the computer device is configured to exchange information between the processor and an external device. The communication interface of the computer device is configured to communicate with an external terminal through a network connection. The computer program is executed by a processor to implement an operation method for a full-analog vector matrix multiplication processing-in-memory circuit.

A person skilled in the art may understand that the structure shown in FIG. 8 is merely a block diagram of partial structure related to the solution of the present disclosure, and does not constitute a limitation on a computer device to which the solution of the present disclosure is applied. A specific computer device may include more or fewer components than those shown in the figure, or combine some components, or have different component arrangements.

In an embodiment of the present disclosure, a computer device is provided, which may include a processor and a memory storing a computer program executable by the processor. When executing the computer program, the processor may implement the following steps of:
inputting analog input data into the device array through the input circuit;
performing vector matrix multiplication computation on the analog input data and a weight value stored in the device array according to the Kirhoff's law and Ohm's law;
clamping an output point of the device array to a zero level by the output clamp circuit, and converting a computation result in the form of current into an output result in the form of voltage; and
performing a shift summation on computation results of columns of devices in the device array by the analog shift summation unit.

In an embodiment of the present disclosure, the processor, when executing the computer program, may further implement the following steps of:

connecting the redundant capacitor to each column capacitor and disconnecting the redundant capacitor from each column capacitor successively to perform the charge distribution, performing a weighted summation on the computation results of the columns of devices, performing a shift summation according to a result of the weighted summation, and outputting a final result of the shift summation by the voltage follower.

In an embodiment of the present disclosure, the processor, when executing the computer program, may further implement the following step of:

outputting, by the voltage follower, the final result of the shift summation V_{O}=Σᵢ₌₀ⁿ⁻¹2ⁱ⁻ⁿVᵢ, where n denotes the number of column capacitors.

In another embodiment of the present disclosure, a computer-readable storage medium is further provided, on which a computer program is stored. The computer program, when executed by a processor, may cause the processor to implement the following steps of:
inputting analog input data into the device array through the input circuit;
performing vector matrix multiplication computation on the analog input data and a weight value stored in the device array according to the Kirhoff's law and Ohm's law;
clamping an output point of the device array to a zero level by the output clamp circuit, and converting a computation result in the form of current into an output result in the form of voltage; and
performing shift summation on computation results of columns of devices in the device array by the analog shift summation unit.

A person of ordinary skill in the art may understand that all or a part of the processes in the methods in the foregoing embodiments may be implemented by a computer program instructing related hardware. The computer program may be stored in a non-transitory computer-readable storage medium. When the computer program is executed, the processes in the foregoing methods embodiments may be included. Any reference to a memory, a database, or another medium used in the embodiments provided in the present disclosure may include at least one of a non-transitory memory or a volatile memory. The non-transitory memory may include a Read-Only Memory (ROM), a magnetic tape, a floppy disk, a flash memory, an optical memory, a high-density embedded non-transitory memory, a Resistive Random Access Memory (ReRAM), a Magnetoresistive Random Access Memory (MRAM), a Ferroelectric Random Access Memory (FRAM), a Phase Change Memory (PCM), a graphene memory, and the like. The transitory memory may include a Random Access Memory (RAM), or an external cache, etc. As an illustration and not a limitation, the RAM may be in multiple forms, such as a Static Random Access Memory (SRAM) or a Dynamic Random Access Memory (DRAM). The databases involved in the embodiments provided in the present disclosure may include at least one of a relational database or a non-relational database. The non-relational database may include a block chain based distributed database or the like, which is not limited thereto. The processor in the embodiments provided in the present disclosure may be a general purpose processor, a central processing unit, a graphics processor, a digital signal processor, a programmable logic device, a quantum computing-based data processing logic device, or the like, which is not limited thereto.

The technical limitations in the above embodiments may be combined in any way. To make the description concise, all possible combinations of the technical limitations in the above embodiments are not described. However, as long as there is no contradiction in the combinations of these technical limitations, these combinations should be considered to be within the scope of the present disclosure.

The above-described embodiments only express several implementation modes of the present disclosure, and the description is relatively specific and detailed, but should not be construed as limiting the scope of the patent disclosure. It should be noted that, those of ordinary skill in the art can make several modifications and improvements without departing from the concept of the present disclosure, and these all fall within the protection scope of the present disclosure. Therefore, the protection scope of the present disclosure should be subject to the appended claims.

What is claimed is:

1. A full-analog vector matrix multiplication processing-in-memory circuit, comprising an input circuit, a device array, an output clamp circuit, and an analog shift summation unit; wherein
the input circuit is configured to sample and hold analog input data, and input the sampled analog input data into the device array;
the device array consists of resistive devices, and is configured to store a weight value in a form of conductance and perform vector matrix multiplication computation on the analog input data and the weight value;
the output clamp circuit is configured to clamp an output point of the device array to a zero level, and convert a computation result in a form of current to an output result in a form of voltage; and
the analog shift summation unit is configured to perform a shift summation on computation results of columns of devices in the device array to complete a carrying computation.

2. The full-analog vector matrix multiplication processing-in-memory circuit according to claim 1, wherein the input circuit is a sample and hold circuit.

3. The full-analog vector matrix multiplication processing-in-memory circuit according to claim 1, wherein the analog shift summation unit comprises column capacitors each of which has a one-to-one correspondence with each column in the device array, a redundant capacitor and a voltage follower, a column capacitor is configured to temporarily store a computation result of each column of devices, the redundant capacitor is configured to perform a weighted summation on the computation results of the columns of devices in the device array, and the voltage follower is configured to output a final shift summation result.

4. The full-analog vector matrix multiplication processing-in-memory circuit according to claim 3, wherein the column capacitors corresponding to the columns in the device array have the same capacitance size, and the redundant capacitor has the same capacitance size with the column capacitor.

5. An operation method for the full-analog vector matrix multiplication processing-in-memory circuit of claim 1, the method comprising:
inputting analog input data into the device array through the input circuit;
performing vector matrix multiplication computation on the analog input data and a weight value stored in the device array according to Kirhoff's law and Ohm's law;
clamping, by the output clamp circuit, an output point of the device array to a zero level, and converting a computation result in a form of current into an output result in a form of voltage; and
performing, by the analog shift summation unit, a shift summation on computation results of columns of devices in the device array to complete a carrying computation.

6. The operation method according to claim 5, wherein the performing, by the analog shift summation unit, the shift summation on the computation results of columns of devices in the device array to complete the carrying computation comprises:
connecting the redundant capacitor to each column capacitor and disconnecting the redundant capacitor from each column capacitor successively to perform charge distribution, performing a weighted summation on the computation results of the columns of devices, performing a shift summation according to a result of the weighted summation, and outputting, by the voltage follower, a final result of the shift summation.

7. The operation method according to claim 6, wherein the final result of the shift summation outputted by the voltage follower is represented as V_{O}=Σᵢ₌₀ⁿ⁻¹2ⁱ⁻ⁿVᵢ, where n denotes the number of the column capacitors.

8. The operation method according to claim 5, wherein for the computation of an N-bit weight value, the step of inputting the analog input data into the device array alternates with the step of the computation of the array vector matrix multiplication, and the shift summation is completed with (N/2+1) analog shift summation units, to implement a pipeline operation of the circuit.

9. A computer device, comprising a processor and a memory storing a computer program executable by the processor, wherein when executing the computer program, the processor implements the method of claim 5.

10. A computer-readable storage medium, on which a computer program is stored, wherein the computer program, when executed by a processor, causes the processor to implement the method of claim 5.

11. The full-analog vector matrix multiplication processing-in-memory circuit according to claim 3, wherein the analog shift summation unit is further configured to connect the redundant capacitor to each column capacitor and disconnect the redundant capacitor from each column capacitor successively to perform charge distribution, perform the weighted summation on the computation results of the columns of devices, and perform the shift summation according to a result of the weighted summation.

12. The full-analog vector matrix multiplication processing-in-memory circuit according to claim 3, wherein the final result of the shift summation outputted by the voltage follower is represented as V_{O}=Σᵢ₌₀ⁿ⁻¹2ⁱ⁻ⁿVᵢ, where n denotes the number of the column capacitors.
